(19) United States
(12) Patent Application Publication
(10) Pub. No.: US 2010/0059970 A1
(43) Pub. Date: Mar. 11, 2010

(54) Multi-purpose carriage

(76) Inventor: Kyle C. Scott, Salem, OR (US)

Correspondence Address: David E. Orr, 4616 NE 134th Street, Vancouver, WA, 98686, US

(21) Appl. No.: 12/453,905

(22) Filed: May 21, 2009

Related U.S. Application Data
(63) Continuation of application No. 12/231,712, filed on Sep. 6, 2008, now abandoned.

(51) Int. Cl. B62B 7/12; B62B 3/02

(52) U.S. Cl. 280/658; 280/659

(57) ABSTRACT

A multipurpose apparatus serving as a luggage carrier and a stroller for a child. The apparatus has multiple compartments for holding diapers and other child items. The wheels and the handle are configured to rotate so that the apparatus may be pushed or pulled on two wheels or four wheels, and the wheels and handle may be disposed so that the apparatus may be stowed in a airplane luggage compartment. The apparatus is configured to receive and carry a child in a car seat, or the handle may be fitted with a back rest so the apparatus may be used as a stroller. The apparatus may also be used without compartments and in this configuration may be used to hold and carry luggage and other objects.

### RELATED APPLICATIONS

This application is related to and derives priority from U.S. application Ser. No. 12/231,712 filed Sep. 6, 2008. This application is included in the present application by reference.

### FIELD

The present invention is an apparatus for carrying a child and holding items related to the care of the child. The apparatus is adaptable to be pushed or pulled on two wheels or four wheels. The wheels may be arranged to facilitate the apparatus being stowed in an overhead luggage compartment. The apparatus may be further configured to serve as a stroller or may receive and attach to a car seat holding the child. The apparatus may also be configured to carry luggage or other objects.

### BACKGROUND

Various folding baby carriages for carrying a baby when taking the baby outdoors for walking or shopping have been proposed. When necessary, the folding baby carriages are folded for easy storage and carrying.

Generally, there have been proposed various folding strollers for carrying a baby outdoors for walking and shopping. Those folding strollers are foldable, when necessary, to facilitate storing or carrying the same, and are provided with a handle that can be set at a back position or a front position.

Portable seats sized to hold an infant or young toddler in the passenger seat of an automobile, otherwise known as car seats, are well-known in the art. The purposes of these car seats are to protect the child and to properly position the child in the car seat for such protection. Car seats may also raise the level of the child slightly to allow a parent or guardian can administer to the child's needs more easily and perhaps to allow the child to see out of a car window. However, some car seats are bulky, lack versatility, and may not provide all the protection needed for the infant or child traveler.

Additionally, while traveling with a child, luggage is also moved or transported, often requiring the use of a wheeled carriage.

### OBJECTS

In view of the foregoing and in response to limitations of the current art, an invention has been made.

A first object of this invention is a conveyance that is a suitcase and a baby stroller, permitting all items needed in the care of the baby to be packed into the suitcase and wheeled onto an aircraft. This means the stroller will not have to be checked as baggage.

As a second object, the invention is a suitcase stroller that no longer has to be scanned separately by airport security.

As a third object, the invention obviates the need for carrying a separate diaper bag.

As a fourth object, a car seat may be attached to the invention and carried as a seat for the baby as the stroller is moved. This means the baby can be wheeled directly to a seat on an airplane, and the stroller detached and stored in the compartment over the seat.

And a fifth object of the invention is a conveyance for luggage or for carrying other objects.

Other benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In an exemplary embodiment, the present invention is disclosed as a multipurpose carriage for carrying an infant or an infant in a car-seat. In the exemplary embodiment the invention is configured with compartments to carry clothes or other items needed by a baby. The invention is configured with adjustable wheels and a handle that may be moved to allow the carriage to be pushed on four wheels or on two wheels as a luggage carrier. The wheels are constructed so that the carriage may be configured as a suitcase stowed in an overhead luggage compartment.

In the exemplary embodiment, the invention is disclosed as a general luggage carrier, wherein the invention may be configured without certain compartments required to carry infants, or the multiple compartments may not be used.

### BRIEF DESCRIPTION OF DRAWINGS

FIG. 1A shows the stroller configured to hold and carry an infant carrier on four wheels.

FIG. 1B shows the stroller configured as a four-wheeled luggage carrier.

FIG. 2A shows the stroller with large compartment opened.

FIG. 2B shows the stroller with small compartment opened.

FIG. 3A shows the stroller configured as a luggage carrier rolled on two wheels.

FIG. 3B shows the apparatus pushed or pulled on two wheels as a luggage carrier. The handle may be disposed and the apparatus stowed in a luggage compartment in this configuration.

FIG. 4 shows the invention configured as luggage to be stowed overhead in a luggage compartment of an airplane.

### DETAILED DESCRIPTION

### An Exemplary Embodiment

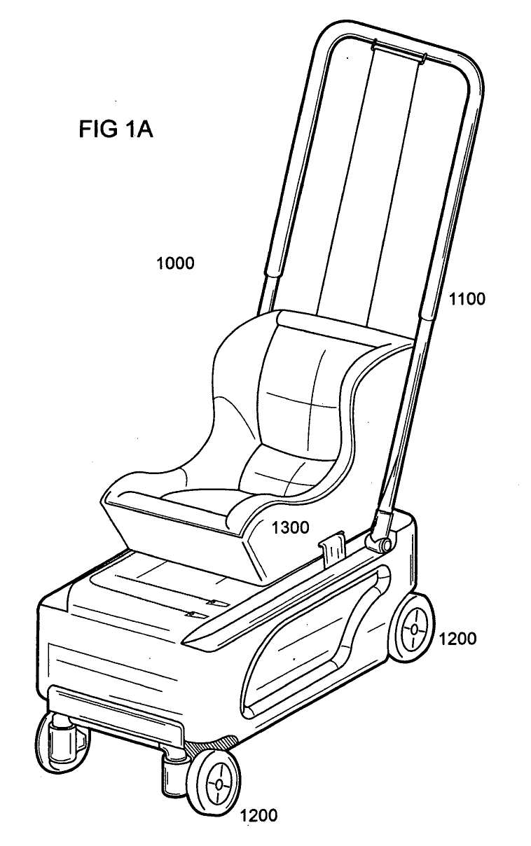

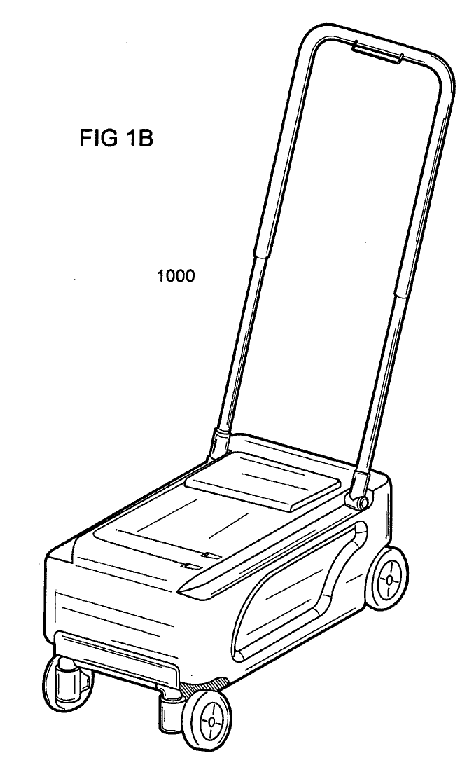

FIGS. 1A, 1B, 2A, 2B, 3A, 3B and 4 illustrate the inventive concept of the invention as an exemplary embodiment. These drawings with the following description should not be construed as limitations of the present invention. It will be appreciated that other arrangements and modifications of the basic inventive elements are possible in view of the teachings that follow.

In the following narrative and in the drawings that accompany this specification, the invention is disclosed as a multi-use stroller, which may be configured as luggage for carrying articles. The handle and wheels of the stroller are made to be changed in position so the stroller made be converted into luggage, which may be stored in an overhead luggage carrier, such as would be found on an airline.

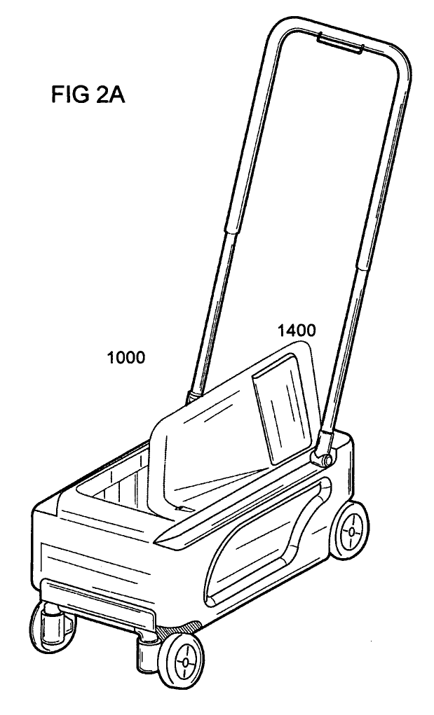

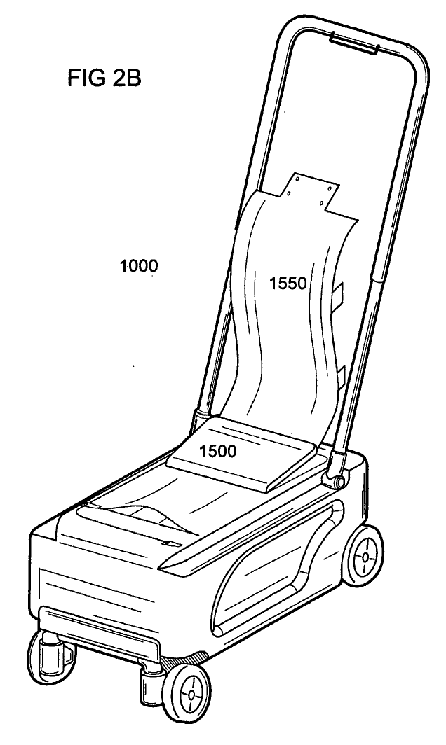

FIG. 1A shows one possible configuration of the invention—a stroller 1000 with multiple compartments, which are shown in FIG. 2A and FIG. 2B and are described in following narrative.

In FIG. 1A, the stroller 1000 may include a detachable seat or carriage 1300 for receiving, holding and carrying a baby. The stroller 1000 is made with a configurable handle 1100 for pushing or pulling, and is equipped with a plurality of wheels 1200, so of which are configured to be rotated or changed in position and to be stowed in a recess in the stroller body.

FIG. 1B shows the stroller 1000 with the seat removed.

FIG. 2A shows a first compartment 1400, which is made to hold or carry items used by the baby, such as clothes, toys, and so forth. The first compartment 1400 is made to be opened, closed and secured by either a zipper or Velcro™, or by other conventional means.

FIG. 2B shows a second compartment 1500, which is used to holds and secures the backrest 1550 as shown in this figure. In this example, the second compartment 1500 is made as part of the first compartment (1400 in FIG. 2A). However, the second compartment could be made to attach elsewhere on the stroller.

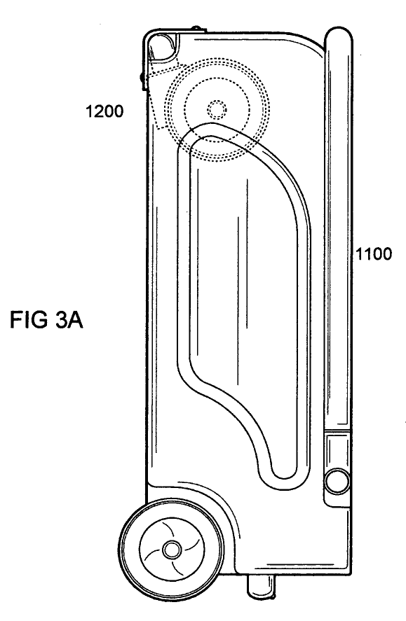

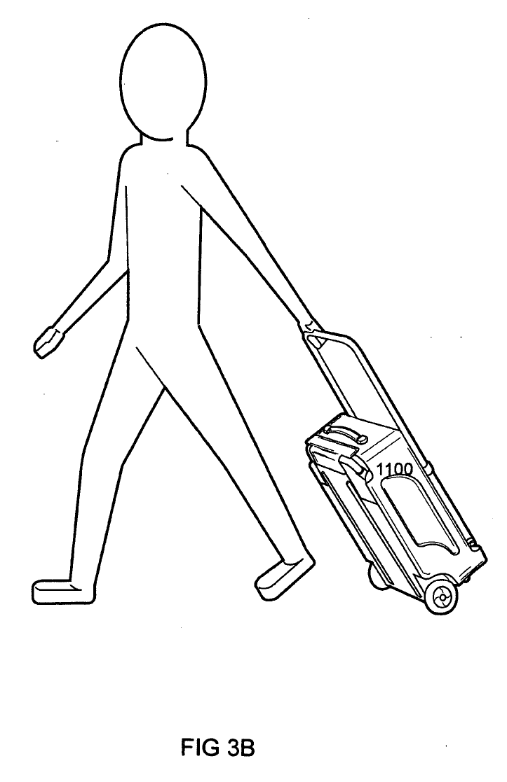

With reference to FIG. 3A, the stroller is shown with certain of the wheels 1200 made to be moved and received by recesses made in the stroller. When so moved the wheels 1200 are more or less hidden. FIG. 3A also shows the stroller when the handle 1100 is rotated and collapsed so the handle 1100 is made flat and stowed against the stroller body.

In FIG. 3B, the handle 1100 of the stroller is shown extended, certain of the wheels stowed in the stroller and the stroller being pulled.

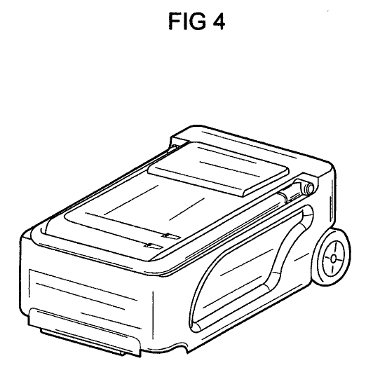

FIG. 4 shows the stroller made ready to stow into a luggage compartment or overhead rack, such as may be found on an air plane.

### DISCLOSURE SUMMARY

The present invention has been disclosed in an exemplary embodiment. The exemplary embodiment teaches an aspect of the invention, from which other configurations and variations may be derived. In the exemplary embodiment, the invention has been disclosed as a suitcase and a baby stroller, permitting all items needed in the care of the baby to be packed into the suitcase and wheeled onto an aircraft, meaning the invention will not have to be checked as baggage and will not be required to be scanned separately by airport security. The invention will obviate the need for carrying a separate diaper bag. Further a seat may be attached to the invention and carried as a seat for the baby as the stroller is moved. This means the baby can be wheeled directly to a seat on an airplane, and the stroller detached and stored in the compartment over the seat. In a second aspect, the invention may be used to hold and convey luggage or other objects.

I claim:

1. An apparatus having a top side and a bottom side, the top side of the apparatus serving as a luggage carrier having a plurality of compartments for storing and carrying items for a child, the apparatus further including:
a handle attached to the top side, the handle for pushing or pulling the apparatus, wherein the handle may be rotated with respect to the top side
four wheels, each attached to the bottom side, two of the wheels positioned at the front and configured to be rotated upward into the bottom side;
whereby the apparatus may be pushed or pulled on said wheels by rotating said handle about the top side of the apparatus and applying a force thereto.

2. The apparatus of claim 1, wherein the top side of the apparatus is adapted to receive and hold a car seat for the child.

3. The apparatus of claim 1, wherein the top side of the apparatus is adapted to receive and hold an infant carrier.

4. The apparatus of claim 1, wherein the handle is adapted to provide a back rest for a child riding thereupon.

5. The apparatus of claim 1, wherein the wheels may be rotated to facilitate stowing the apparatus in an airline luggage compartment.

6. The apparatus of claim 1, wherein the wheels at a common end of the apparatus may be rotated, the handle rotated and the apparatus may be pushed or pulled.

7. The apparatus of claim 1, wherein a compartment is adapted to receive a back rest.

8. An apparatus having a top side and a bottom side, the top side of the apparatus serving as a luggage carrier, the apparatus comprising:
a handle attached to the top side for pushing or pulling the apparatus, wherein the handle may be rotated with respect to the top side;
four wheels, each attached to the bottom side, two of said wheels made to rotate upward into the bottom side;
whereby the apparatus may be pushed or pulled on said wheels by rotating said handle about the top side of the apparatus and applying a force thereto.
